(19) United States
(12) Patent Application Publication
(10) Pub. No.: US 2026/0159424 A1
(43) Pub. Date: Jun. 11, 2026

(54) BIODEGRADABLE LAVATORY COMPOSITION WITH LOW FREEZE POINT

(71) Applicant: 15590710 Canada Inc., Brossard (CA)

(72) Inventor: Rafik MIKHAIL, Brossard (CA)

(73) Assignee: 15590710 Canada Inc., Brossard (CA)

(21) Appl. No.: 18/982,885

(22) Filed: Dec. 16, 2024

(30) Foreign Application Priority Data
Dec. 6, 2024 (CA) 3258647

(51) Int. Cl. C02F 1/68; C02F 1/50; C02F 103/00

(52) U.S. Cl. CPC C02F 1/68; C02F 1/50; C02F 2103/005; C02F 2303/02; C02F 2303/04; C02F 2303/08; C02F 2303/12; C02F 2305/04

(57) ABSTRACT

The present invention provides novel biodegradable lavatory compositions comprising potassium formate that has been neutralized from any free ionic radicals. The composition may further comprise a surfactant, a fragrance, a colorant, siloxane defoamers, glycerin and water. The compositions remain in fluid in cold weather, are biodegradable and meet regulations to be disposed off directly into sewer after use.

### RELATED APPLICATION

This application claims priority to Canadian application number 3,258,647, filed on Dec. 6, 2024, and is hereby incorporated by reference for all purposes.

### FIELD OF THE INVENTION

This application pertains to a biodegradable lavatory composition designed for use in low-temperature environments. The composition is specifically engineered to ensure safe disposal within municipal sewage systems without necessitating additional treatment processes.

### BACKGROUND

Lavatory fluids with freeze depressants are used in various industries, including locomotives, aircrafts, mass transit, marine, recreational vehicles, transport vehicles, and construction sites and portable toilets. Traditional lavatory fluid for use in temperatures below the freezing point are generally formulated with a freeze depressant that is either a hydrocarbon such as glycols, organics such as urea, or salts or modified salts such as magnesium chloride, calcium magnesium acetate and potassium acetate. In more recent years many lavatory fluids for use in below freezing conditions formulations utilise potassium acetate as a freeze depressant because of its relative better biodegradability when compared to other freeze depressant referenced above.

Lavatory fluid using potassium acetate as a freeze depressant do not have the high or rapid biodegradability required to allow direct disposal down city sewer without further treatment. Users of such fluids must therefore capture and store the spent solution of a potassium acetate-based lavatory fluid and dispose of it through an environmentally certified organisation.

The current lavatory formulations have limitations in terms of their environmental sustainability and effectiveness. For example, their biodegradability may not be low enough to qualify direct disposal of the effluent in municipal sewers and may require treatment.

The need exists to develop lavatory compositions with freeze depressants for low temperatures that could be disposed off directly into North American city sewer meeting all municipal tolerable limits including biodegradability, chemistry hydrocarbon, metals and volatile organic compound (VOC).

There is a need for a lavatory composition that obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of embodiments of the present invention is to provide novel biodegradable lavatory compositions designed for safe disposal of spent solution directly in municipal sewage systems.

In accordance with an aspect of the present invention, there is provided novel biodegradable lavatory compositions designed for use in low-temperature environments.

In accordance with another aspect of the present invention, there is provided biodegradable lavatory compositions comprising potassium formate neutralized from any free ionic radicals. The biodegradable lavatory compositions may further include surfactants, fragrances, colorants, defoamers, metal protector and water.

In accordance with another aspect of the present invention, there is provided a biodegradable lavatory composition comprising: about 45% by weight of potassium formate; about 0.15% by weight of polyoxyethylene alkyl phosphate ester; about 0.25% by weight of deceth-4 phosphate; about 0.1% by weight of fragrance; about 0.03% by weight of siloxane defoamer; about 0.2% by weight of glycerin, about 0.0025% by weight of colorant; and the balance is water.

In accordance with another aspect of the present invention, there is provided biodegradable lavatory compositions with a five-day Biological Oxygen Demand (BOD5) is less than about 300 ppm.

In accordance with another aspect of the present invention, there is provided biodegradable lavatory compositions with a five-day Biological Oxygen Demand (BOD5) is less than about 220 ppm.

In accordance with another aspect of the present invention, there is provided biodegradable lavatory compositions with a five-day Biological Oxygen Demand (BOD5) is 200 ppm.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows a comparative biodegradability data chart for an embodiment of the present disclosure compared to the currently available technology.

It will be noted that throughout the appended drawings, like features are identified by like reference numerals.

### DETAILED DESCRIPTION OF THE INVENTION

Unless defined otherwise, all technical and scientific terms used herein have the same meaning as commonly understood by one of ordinary skill in the art to which this invention belongs.

The word “a” or “an” when used in conjunction with the term “comprising” or “including” in the claims and/or the specification can mean “one”, but it is also consistent with the meaning of “one or more”, “at least one”, and “one or more than one” unless the content clearly dictates otherwise. Similarly, the word “another” can mean at least a second or more unless the content clearly dictates otherwise. The phrase “at least one” means one or more, and “a plurality of” means two or more. In addition, “and/or” describes an association relationship of associated objects, and indicates that there can be three relationships. For example, A and/or B can indicate cases including “only A”, “both A and B”, and “only B”, where A and B can be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” can represent “a”, “b”, “c”, “a and b”, “a and c”, “b and c”, or “a, b and c”, where a, b, and c can be a single or multiple form.

The term “and/or” herein when used in association with a list of items means any one or more of the items comprising that list.

As used herein, the term “about” should be read as including variation from the nominal value, for example, a +/−10% variation from the nominal value. It is to be understood that such a variation is always included in a given value provided herein, whether or not it is specifically referred to.

It is to be understood that such a variation is always included in a given value provided herein, whether or not it is specifically referred to.

The term “alkyl” refers to a straight chain or branched, alkyl group of one to ten carbon atoms. This term is further exemplified by such groups as methyl, ethyl, n-propyl, i-propyl, n-butyl, t-butyl, 1-butyl (or 2-methylpropyl), and the like.

As used herein, the term “hydroxyalkyl” refers to an alkyl group substituted with at least a hydroxyl group. This term is further exemplified by such groups as hydroxymethyl, 2-hydroxyethyl, 2-hydroxybutyl, 4-hydroxybutyl, 2,3-dihydroxypropyl, etc.

Weight percent, percent by weight, % by weight, wt %, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4 and 5).

### The Compositions

The present invention provides novel biodegradable lavatory compositions comprising potassium formate that has been neutralized from any free ionic radicals. The compositions remain in fluid in cold weather, are biodegradable and meet all regulations to be disposed off directly into sewer after use.

In accordance with another aspect of the present invention, the compositions may further comprise one or more of a surfactant, a fragrance, a colorant, siloxane defoamers, glycerin and water

### Potassium Formate

The potassium formate of the present invention is the potassium salt of formic acid.

It has the chemical formula: KHCOO and may be represented by the molecular formula:

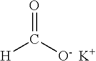

Potassium formate in powder or as a solution in water is neither toxic nor corrosive.

Formate salts tend to harbor more free radicals/ions and tend to be less stable than acetate salts. Having more free radicals can make a solution less biodegradable so using formate salts as a precursor to create a composition that is more biodegradable than the current acetate composition would not be an obvious choice of a precursor. The potassium formate solution of the present invention is therefore preferably neutralized from any hydroxide (OH) or formic acid free ions to have the desired maximum effect on the low freeze point desired in the invention as well as the maximum bioavailability.

Potassium formate functions as a freezing point depressant for lowering the freezing point of the aqueous solution to permit use in low temperature environments. The potassium formate may be present in an amount up to about 52 weight % of the composition.

In one embodiment, the addition of potassium formate in the amount of about 10 weight % of the composition depress the freezing point of the composition to about 27° F. (−3° C.).

In one embodiment, the addition of potassium formate in the amount of about 45 weight % of the composition would depress the freezing point of the composition to about −43.6° F. (−42° C.).

In one embodiment, potassium formate is incorporated in the amount of about 40 weight % and potassium acetate is added in the amount of about 5 weight %, both as freeze depressant, along with other components in the composition would depress the freezing point of the composition to about −58° F. (−50° C.).

In one embodiment, the range of potassium formate in the total composition contemplated by the invention is 10% to 52%. The percentage of potassium formate in the final composition is directly proportional to the temperature protection. those skilled in the art will appreciate, the particular amount of potassium formate will depend upon the level of freezing point depression desired as well as the other components in the final biodegradable toilet composition.

Compositions of the present invention have similar freeze points as other freeze depressants, but when integrated adequately in formulation of the present invention, it provides such high biodegradability allowing it as spent solution to be directly disposed of down city sewers.

In an embodiment, potassium formate may be present in an amount from about 10 weight % to 52 weight % of the composition.

In other embodiments, potassium formate may be present in an amount of 10-25 weight %, 25-40 weight %, 40-52 weight % of the composition.

In one embodiment, the potassium formate may be present in an amount of about 10%, 15%, 20%, 25%, 30%, 35%, 40%, 45%, 50%, 52%, or a percentage between any two of these values.

In one embodiment, the maximum freezing point depression attainable with potassium formate as the sole freezing point depressant with the other components of the composition of the present invention is achieved at a potassium formate concentration of about 45 weight % of the composition.

The aqueous potassium formate solutions of the present invention are not flammable, are non-toxic to humans and other species.

### Fragrances

Deodorizing fragrances are generally concentrates and provide various scents that are pleasing to olfactory senses. Preferably the fragrances have a low odor detection threshold. Suppliers of present portable toilet solutions advertise several fragrances to choose from, such as Apple, Bubble Gum, Cherry, Lemon, Mountain Breeze, Mulberry Twist, Spice and Sunshine (Satellite Industries, Minneapolis, Minn.). Additionally, fragrances and deodorizers are primarily comprised of terpenes, limonene, essential oils, alcohols, methyl ethers, ethyl esters, aldehydes, ketones, N-alkyl-N-ethylmorpholinium ethyl sulfate and hydrophilic perfumes.

In an embodiment, the fragrance may be present in an amount from about 0.01%-2% weight of the composition.

In an embodiment, the fragrance may be present in an amount of about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9 and 2.0% weight of the composition or a percentage between any two of these values.

### Dyes

Various dyes may also be included in the composition of the present invention.

Colorants most usually are in dark blue/green hues. The preferred colorants may be of darker hues to hide the wastes submerged in the solution. Dyes may be included to alter the appearance of the composition or used as a monitoring tool, as for example, any water soluble or product soluble dye, any Food, Drug, and Cosmetic (“FDC”) approved dye by the US Food and Drug Administration, FDC blue #3, and the like.

In an embodiment, the dye may be present in an amount from about 0.001%-0.5% weight of the composition.

In an embodiment, the fragrance may be present in an amount of about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, and 0.5% weight of the composition or a percentage between any two of these values.

In a preferred embodiment, the dye may be present in an amount of 0.0025% weight of the composition.

### Phosphate Ester

The compositions of the present invention may contain one or more surfactants. The surfactants are preferably phosphate esters. A phosphate ester generally refers to a composition having the formula (RO)P—O and may be represented by the molecular formula

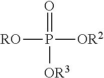

The phosphate ester surfactant has the general structure wherein R, R¹ and R² may be hydrogen, an alkyl of from 1 to about 22 carbons, preferably from about 12 to 18 carbons, or an alkoxylated alkyl of from 1 to about 22 carbons, preferably from about 12 to 18 carbons, and having 1 or more, preferably from about 2 to about 25, most preferably 2 to 12, moles ethylene oxide, with the proviso that at least one of R, R¹ and R² is an alkyl or alkoxylated alkyl as previously defined but having at least 6 alkyl carbons in said alkyl or alkoxylated alkyl group.

In an embodiment, the phosphate ester surfactant may be present in an amount of about 0.10, 0.20, 0.30, 0.40, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9 and 6.0% weight of the composition or a percentage between any two of these values.

Various phosphate esters and other surfactants were tested for compatibility with the potassium formate solution and for providing detergent, emulsifying and wetting properties to the composition. The two phosphate esters of the preferred embodiment provided optimum required performance when combined with the other components of the composition.

In one embodiment, the phosphate ester is an alkyl alkoxylated phosphate ester and more preferably an ethoxylated and/or propoxylated phosphate ester having the general structural formula: R—O—(RO), POX, wherein R′ comprises an alkyl group (e.g., linear, branched or cyclic alkyl group) of from 1 to 20 carbon atoms, preferably 8 to 12 carbon atoms, R′ is selected from —CH, CH and CH3-CH—CH (ethylene and propylene) n is 3 to 8 where R is propylene, and 3 to 10 where R is ethylene, and X is hydrogen, alkanolamine and/or alkali metal. Alkyl phosphate esters are available commercially under the names: Rhodafac (i.e., Rhodafac PC-100, Rhodafac PL-620, Rhodafac PL-6, and Rhodafac RA 600) from Rhodia, Inc. of Cranberry, N.J.; Emphos (Emphos PS-236) from Witco Corporation of Greenwich, Conn.; DePhos (i.e., DePhos RA-40, DePhos RA-60, DePhos RA-75, DePhos RA-80); and Ethfac (i.e., Ethfac 141, Ethfac 161, Ethfac 104, Ethfac 106, Ethfac 136, and Ethfac 124) of Ethox Chemicals, LLC of Greenville, S.C.

The phosphate ester is preferably a polyoxyethylene alkyl phosphate ester (acid form), Such as the phosphate ester sold under the tradename Rhodafac RA 600, commercially available from Rhodia. Rhodafac RA 600 showed comparability with high percentage of electrolytes found in final 100% biodegradable winter toilet chemical.

The concentrate preferably includes a sufficient lubricating amount of alkyl phosphate ester to provide the use composition with a desired lubricity. The amount of alkyl alkoxylated phosphate ester provided is sufficient to provide a desired level of surfactants properties as well as lubricity. Too much alkyl alkoxylated phosphate ester may increases viscosity, decrease the level of biodegradability required from the final product formulation but more importantly will take away from the limited amount of solvent (H2O) available and needed in the final formulation. In addition, the ratio of anionic and cationic species present in the lubricant composition should be sufficient to avoid phase separation. Accordingly, too little or too much alkyl alkoxylated phosphate ester relative to the other components can result in phase separation.

The alkyl phosphate ester is preferably provided in the final innovative formulation from about 0.01 wt. % to about 3 wt. % of the composition. The skilled worker in the art would appreciate that the percent weight alkyl phosphate ester in the formulation can be increased beyond 3%, however this would be at the expense of compositions performance.

In an embodiment, the alkyl phosphate ester may be present in an amount of about 0.10, 0.20, 0.30, 0.40, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9 and 6.0% weight of the composition or a percentage between any two of these values.

In an embodiment, the alkyl phosphate ester may be present in an amount of 0.015% weight of the composition.

In an embodiment, the composition includes a suitable anionic phosphate surfactant. In a preferred embodiment, the anionic phosphate surfactants is deceth-4 phosphate which is available commercially as CEDEPHOS® FA600. The deceth-4 phosphate properties was shown to provide hard water stability for the composition's water when diluted in the tank waste, along with other standard surfactant characteristics and properties, as well as level of biodegradability. The degree of biodegradability of the innovative formula allows for the spent product (effluent) to be directly disposed of into municipal city sewer.

In an embodiment, the deceth-4 phosphate may be present in an amount of about 0.10, 0.20, 0.30, 0.40, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9 and 6.0% weight of the composition or a percentage between any two of these values.

In an embodiment, the composition includes a phosphate ester surfactant comprises polyoxyethylene alkyl phosphate ester and deceth-4 phosphate.

In an embodiment, the composition includes a phosphate ester surfactant comprises polyoxyethylene alkyl phosphate ester in an amount of about 0.10, 0.20, 0.30, 0.40, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 and 3.0% weight of the composition or a percentage between any two of these values, and deceth-4 phosphate in an amount of about 0.10, 0.20, 0.30, 0.40, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 and 3.0% weight of the composition or a percentage between any two of these values.

In a preferred embodiment, the composition includes polyoxyethylene alkyl phosphate ester is 0.15% by weight of the composition and deceth-4 phosphate is 0.25% by weight of the composition.

### Anticorrosion Agents

The composition of the present invention may include an anticorrosion agent. Anticorrosion agents provide compositions surface protection protects all metallic surfaces against rust and corrosion. It also generates a shinier surface and a surface that is less prone to biofilm buildup on all surface components like steel and stainless steel.

In one embodiment, the anticorrosion agent included in the composition is glycerin.

Glycerin has a number of characteristics that favor its use in an environmentally friendly and biodegradable composition. First, glycerin is non-toxic, non-flammable and environmentally benign and is “Generally Regarded as Safe” (GRAS) by FDA and an approval for use as direct food additives, mixtures of the glycerin and propylene glycol could also be used as direct food additives. Neither glycerin nor propylene glycol has a measurable flash point when mixed with at least 15 weight % water. As such, the lavatory compositions of various embodiments of this invention should pose no risk of ignition. Glycerin is considered to be readily bio-degradable and can be produced from bio-renewable sources.

The glycerin is preferably provided in the concentrate from about 0.01 weight % to about 3% weight of the composition.

In one embodiment, the glycerin may be present in an amount of about 0.02% weight of the composition.

### Antifoam Agents

The composition of the present invention may include an antifoam agent (also known as a defoamer) aids for foam control, improving and maintaining flow pressure and drainage filtration.

In one embodiment, the antifoams of the present invention comprise siloxanes.

In one embodiment, the composition comprises about 0.1 to 3% by weight of antifoam agent. As will be appreciated by those skilled in the art, the amount of antifoam added to the composition could be less or more than the 0.1 to 3% range, however it will affect the final formulation performance (short/long term).

In one embodiment, the composition comprises about 0.1 to 3% by weight of siloxane defoamer.

In one embodiment, the composition comprises 0.03% by weight of siloxane defoamer.

In one embodiment, in the composition of the present invention the amount of potassium formate neutralized from any free ionic radicals, free of potassium hydroxide formic acid, potassium positive ion as well as formate negative ion in a range of about 10 to 52% of the total weight of the composition, the amount of fragrance is in a range of about 0.01 to 2% of the total weight of composition, the amount of colorant is in the range of about 0.001 to 1.0% by weight of colorant, and the balance is water. In one embodiment, in the composition of the present invention the amount of phosphate ester surfactant is in a range of about 0.1 to 3% by weight of the total weight of the composition, the amount of glycerin is in a range of about 0.1 to 2% by weight of the total weight of the composition, and the amount of siloxane defoamer is in a range of about 0.1 to 2% by weight of the total weight of the composition.

In one embodiment, in the composition of the present invention the amount of potassium neutralized from any free ionic radicals, free of potassium hydroxide formic acid, potassium positive ion as well as formate negative ion is about 45% of the total weight of the composition, the amount of fragrance is about 0.15% of the total weight of composition, the amount of colorant is about 0.0025% by weight of the total weight of the composition, the amount of phosphate ester surfactant is about 0.4% by weight of the total weight of the composition, the amount of glycerin is about 0.2% by weight of the total weight of the composition, and the amount of siloxane defoamer is about 0.3% by weight of the total weight of the composition and the balance is water.

In one embodiment, in the composition of the present invention the amount of potassium formate neutralized from any free ionic radicals, free of potassium hydroxide formic acid, potassium positive ion as well as formate negative ion is 45% of the total weight of the composition, the amount of fragrance is 0.15% of the total weight of composition, the amount of colorant is 0.0025% by weight of the total weight of the composition, the amount of phosphate ester surfactant is 0.4% by weight of the total weight of the composition, the amount of glycerin is 0.2% by weight of the total weight of the composition, and the amount of siloxane defoamer is 0.3% by weight of the total weight of the composition and the balance is water.

In one embodiment, in the composition of the present invention, the amount of completely neutralised potassium formate, free ionic radicals, free of potassium hydroxide formic acid, potassium positive ion as well as formate negative ion is 45% of the total weight of the composition, the amount of fragrance is 0.15% of the total weight of composition, the amount of colorant is 0.0025% by weight of the total weight of the composition, the amount of Rhodafac® RA 600 surfactant is 0.15% by weight of the total weight of the composition and the amount of Cedaphos® FA600 surfactant is 0.25% by weight of the total weight of the composition, the amount of glycerin is 0.2% by weight of the total weight of the composition, and the amount of siloxane defoamer is 0.3% by weight of the total weight of the composition and the balance is water.

### Additional Properties

The compositions of the present invention present a clear advantage in biodegradability over the current technology expressed in the higher biodegradability & associated low BOD 5 tested. The compositions do not require treatment and/or further dilution. The spend product can be discharged directly into municipal sewer. That is a complete contrast to all current technology blends incorporating potassium acetate freeze depressants, which basically cannot be discharged directly into sewer systems in north American city sewer system and has to be collected stored and disposed of through an approved disposal outfit.

In one embodiment, the compositions of the present invention have a pH value of about 8.0 to 9.5.

In one embodiment, the compositions of the present invention have a five-day Biological Oxygen Demand (BOD5) of less than about 300 ppm.

In one embodiment, the compositions of the present invention have a five-day Biological Oxygen Demand (BOD5) of less than about 220 ppm.

In one embodiment, the compositions of the present invention have a five-day Biological Oxygen Demand (BOD5) of 200 ppm.

For a more complete understanding of the invention, the following examples are given to illustrate some embodiments. These examples and experiments are to be understood as illustrative and not limiting. All parts are by weight, except where it is contrarily indicated.

### EXAMPLE

The following chart provides a brief explanation of certain chemical components used in the following example:

TABLE 1
Trade Names and Corresponding Descriptions
of Some Chemicals Used in the Examples

| Trademark/Chemical Name | Description | Provider or CAS Number |
|---|---|---|
| Formic acid potassium salt | Potassium formate powder | CAS Number: 590-29-4 |
| RhodafacRA 600 | Polyoxyethylene Alkyl | Rhodia |
| | Phosphate Ester Acid | |
| Cedephos FA-600 | deceth-4 phosphate | Stepan Company |
| Apple fragrance 10501 | Fragrance | Fluorarome Fragrances in |
| | | Montreal, Quebec |
| Siloxane emulsion defoamer | Aqueous concentrated | As is or modified. Dow |
| | siloxane emulsion | Chemicals. |
| Glycerin | Organic emulsifying moiety | As is or modified. Quadra |
| | for general emulsification, | Chemicals. |
| | flow as well as metal | |
| | protection | |
| Blue dye #3 | Standard toilet dye | Local supplier |

### Method of Preparation of Composition

An aqueous solution of potassium formate is produced by mixing the potassium formate powder in water. Since potassium formate is a salt of a weak acid (formic acid), its solutions tend to be slightly alkaline (basic). The next step is to neutralize the aqueous solution of potassium formate by ensuring that there are no free radicals in the solution. This can be achieved by neutralizing the solution using a PH meter and adding Formic Acid (HCOOH) or Potassium Hydroxide (KOH) to achieve a solution having a PH of about 6.8.

The other elements, fragrance, colorant, optional phosphate ester surfactant, optional, and optional siloxane defoamer and a top up of water are added in percentages desired for a given product.

### Example 1

The following composition was prepared:

| | Weight % of Total |
|---|---|
| Component | Composition |
| water | 54.27 |
| potassium formate neutralized from any free | 45% |
| ionic radicals, free of potassium hydroxide | |
| formic acid, potassium positive ion as well as | |
| formate negative ion | |
| Rhodafac RA 600 | 0.15% |
| Cedaphos FA600 | 0.25% |
| Fragrance | 0.1% |
| Defoamer/siloxane | 0.03% |
| Glycerin | 0.20% |
| Blue dye #3 | 0.0025% |

### Specifications

The composition of Example 1 has the following specifications:

| APPEARANCE | Colorless and odorless |
|---|---|
| pH | 8.72 |
| Specific Gravity | 1.28-1.30 |
| Boiling Point | 100° C. (212° F.) |
| Freeze point | −41.80 degree |
| | Celsius |
| Solubility in water | 100% |
| Cloud point | >40 degrees |
| | Celsius |

Requirements for Disposal into Municipal Sewers in North America

In order for lavatory compositions and other materials to be disposed of directly into sewer system they must meet certain thresholds including low toxicity, high water solubility, moderate pH and be biodegradable or easily degradable by wastewater treatment processes. Sewer requirements for Montreal, Toronto, Vancouver and most cities in North America are similar. The requirements include a pH in the range of 6-10.5), a BOD5: <300 mg/L or ppm and limits for cyanide, fluoride, total nitrogen and oils and grease. For example, the Toronto Municipal Code, Chapter 681 on Sewers dated May 15, 2023 set the limits for sanitary and combined sewers discharge pursuant to Amended 2002 Oct. 31 by By-law 855-2002, 2010 Jul. 8 by By-law 868-2010 and 2016 Feb. 4 by By-law 100-2016 as follows:

| Parameter | Limit | Unit |
|---|---|---|
| pH | >6.0 to <11.5 | SU |
| Temperature | <60 | Degrees |
| | | Celsius |
| Biochemical oxygen demand | 300 | mg/L³ |
| Cyanide (total) | 2 | mg/L³ |
| Fluoride | 10 | mg/L³ |
| Total Kjeldahl Nitrogen | 100 | mg/L³ |
| Oil and grease - animal and vegetable | 150 | mg/L³ |
| (non-mineral)¹ | | |
| Oil and grease - mineral | 15 | mg/L³ |
| and synthetic | | |
| Phenolics (4AAP) | 1.0 | mg/L³ |
| Phosphorus (total) | 10 | mg/L³ |
| Suspended solids (total) | 350 | mg/L³ |
| Aluminum (total) | 50 | mg/L³ |
| Antimony (total) | 5 | mg/L³ |
| Arsenic (total) | 1 | mg/L³ |
| Cadmium (total) | 0.7 | mg/L³ |
| Chromium (hexavalent) | 2 | mg/L³ |
| Chromium (total) | 4 | mg/L³ |
| Cobalt (total) | 5 | mg/L³ |
| Copper (total) | 2 | mg/L³ |
| Lead (total) | 1 | mg/L³ |
| Manganese (total) | 5 | mg/L³ |
| Mercury (total) | 0.01 | mg/L³ |
| Molybdenum (total) | 5 | mg/L³ |
| Nickel (total) | 2 | mg/L³ |
| Selenium (total) | 1 | mg/L³ |
| Silver (total) | 5 | mg/L³ |
| Tin (total) | 5 | mg/L³ |
| Titanium (total) | 5 | mg/L³ |
| Zinc (total) | 2 | mg/L³ |
| 1,1,2,2-tetrachloroethane | 1.4 | mg/L³ |
| 1,2-dichlorobenzene | 0.05 | mg/L³ |
| 1,4-dichlorobenzene | 0.08 | mg/L³ |
| 3,3′-dichlorobenzidine | 0.002 | mg/L³ |
| Benzene | 0.01 | mg/L³ |
| Bis (2-ethylhexyl) phthalate | 0.012 | mg/L³ |
| Chloroform | 0.04 | mg/L³ |
| Cis-1,2-dichloroethylene | 4 | mg/L³ |
| Di-n-butyl phthalate | 0.08 | mg/L³ |
| Ethyl benzene | 0.16 | mg/L³ |
| Methylene chloride | 2 | mg/L³ |
| Nonylphenols | 0.02 | mg/L³ |
| Nonylphenol ethoxylates² | 0.2 | mg/L³ |
| PCBs | 0.001 | mg/L³ |
| Pentachlorophenol | 0.005 | mg/L³ |
| Tetrachloroethylene | 1 | mg/L³ |
| Toluene | 0.016 | mg/L³ |
| Total PAHs² | 0.005 | mg/L³ |
| Trans-1,3-dichloropropylene | 0.14 | mg/L³ |
| Trichloroethylene | 0.4 | mg/L³ |
| Xylenes (total)² | 1.4 | mg/L³ |

Footnote¹:
The noted parameter is calculated.
Footnote²:
The noted parameters have calculated totals.
Footnote³:
mg/L is expressed in milligrams per litre.

### Biodegradability

The environmental impact of chemicals is mainly linked to the Biochemical Oxygen Demand (BOD) and the time it takes for the chemical to break down.

The composition of Example 1 was tested using the widely used 5-Day Biochemical Oxygen Demand (BOD5) method for assessing the biodegradability and pollution potential of wastewater, effluent, or industrial discharges. The test involves placing a sample of the water into a sealed container with a controlled atmosphere and microorganisms (typically a mixture of aerobic bacteria). Over a 5-day period, the microorganisms consume the organic matter in the sample, using up oxygen in the process. By measuring the decrease in dissolved oxygen levels at the end of the test, researchers can determine the BOD5 value, which is expressed as milligrams per liter (mg/L) of oxygen consumed. A higher BOD5 value indicates that the water contains lower biodegradability matter and potentially poses a greater risk to aquatic ecosystems through direct disposal. The BOD5 test is commonly used by regulatory agencies, wastewater treatment plants, and industry to monitor compliance with environmental regulations and optimize treatment processes.

Currently available lavatory compositions in the market using 50% by weight of potassium acetate have a BOD5 at 20° C. of at least 2,000 Parts Per Million (ppm)/Milligrams per Liter (mg/L) or 0.21 Kg Oxygen per Kg of fluid Product (winter toilet chemical fluid).

The testing revealed that the composition of Example 1 has a much lower Biochemical Oxygen Demand (BOD) than acetate-based lavatory compositions.

The composition of Example 1 had a BOD5 at 20° C. of about 200 ppm/mg/L.

The different concentrations of the compositions contemplated in the present invention have a BOD5 value in the range of 175 ppm to 220 ppm at full electrolyte concentration which are all significantly lower than potassium acetate-based compositions. If water in the formation is softened before use the compositions contemplated in the present invention have an even lower BOD5 value in the range of 100 ppm to 112 ppm.

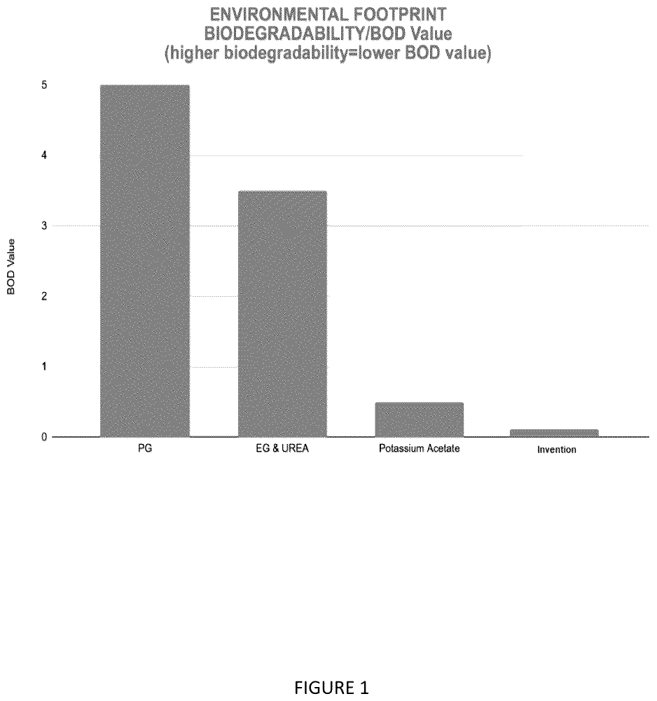

FIG. 1 is a diagram comparing the biodegradability (BOD) values of the composition of Example #1 versus (1) propylene glycol (PG), (2) ethylene glycol (EG) and urea and (3) potassium acetate only composition. The composition of Example #1 was more than 10 times more biodegradable than potassium acetate blends.

The composition of Example 1 was also tested for metals and Polychlorinated biphenyls (PCBs). Below are the results of the testing:

| | | Method | | Results of |
|---|---|---|---|---|
| | | Reporting | | Example |
| Group | Analyte | Limit | Units | #1 |
| Metals | Ag (Silver) | 0.5 | mg/L | <0.5 |
| | Al (Aluminum) | 5 | mg/L | <5 |
| | Aqua-Regia | — | mg/L | Y |
| | Digest | | | |
| | As (Arsenic) | 1 | mg/L | <1 |
| | Cd (Cadmium) | 0.4 | mg/L | <0.4 |
| | Co (Cobalt) | 0.5 | mg/L | <0.5 |
| | Cr (Chromium) | 2 | mg/L | <2 |
| | Cu (Copper) | 0.5 | mg/L | <0.5 |
| | Fe (Iron) | 5 | mg/L | 38 |
| | Mn (Manganese) | 0.5 | mg/L | <0.5 |
| | Mo | 0.5 | mg/L | <0.5 |
| | (Molybdenum) | | | |
| | Ni (Nickel) | 0.5 | mg/L | <0.5 |
| | Pb (Lead) | 0.5 | mg/L | <0.5 |
| | Sb (Antimony) | 0.5 | mg/L | <0.5 |
| | Se (Selenium) | 1 | mg/L | <1 |
| | Sn (Tin) | 5 | mg/L | <5 |
| | Ti (Titanium) | 0.05 | mg/L | <0.05 |
| | Zn (zinc) | 2 | mg/L | <2 |
| PCBs | Polychlorinated | 0.1 | mg/L | <0.1 |
| | biphenyls | | | |

Example 1 was also subjected to corrosion testing on copper, solder, brass, stainless, cast iron, bare aluminum, alclad aluminum, anodized aluminum/alloy, magnesium alloy, carbon steel and steel in accordance to ASTM D-1384. Below are the results:

### A. Corrosion Testing on Metal Surface (ASTM D 1384)

| Test | Result |
|---|---|
| Copper UNS C 2300 coupon | Pass |
| Solder UNS L 54915 coupon | Pass |
| Brass UNS C26000 coupon | Pass |
| Stainless Steel UNS G10200 | Pass |
| coupon | |
| Aluminum UnS A 03190 coupon | Pass |
| Cast Iron UNS F 12801 coupon | Pass |
| Extreme copper testing using ARP | Pass |
| 1755 | |

### B. Tests on Rubber/Elastomers/Plastics

| Test | Result |
|---|---|
| Elastomers using compression set | Pass |
| test, post pressure Type 1 FKM | |
| (ASTM 1418) | |
| Stretched Acrylic test using MIL-P- | Pass |
| 25690 | |
| Plastic Polycarbonate using | Pass |
| MIL - P - 83310 | |
| Transparent Plastics using | Pass |
| MIL - P - 25690 Type C/MIL - 83310 | |

C. Additional corrosion testing was done on the Example 1 composition for the following metals as it relates to ASTM 1435C Method:

| Test | Result |
|---|---|
| Entailing Bare Aluminum 2024 - T3 | Pass |
| Alclad Aluminum 2024-T3 | Pass |
| Bare Anodised Aluminum 2026-T6 | Pass |
| Alclad Aluminum 2025-T6 | Pass |
| Aluminum Alloy/Anodised | Pass |
| Aluminum AMS 2470 | |
| Magnesium alloy AMS 4376 | Pass |
| Carbon Steel AMS 5045 | Pass |
| Steel AMS 4130 | Pass |

### Sanitizing/Disinfectant Properties

The composition of Example 1 included a disinfectant and an anti-microbial moiety that exhibited excellent antimicrobial activity, demonstrating a rapid speed of kill even in the presence of proteins and enzymes. At concentrations below 300 ppm, the disinfectant in the composition exhibited minimum inhibitory concentrations against gram-positive bacteria such as Staphylococcus aureus and Bacillus subtilis, gram-negative bacteria including Klebsiella pneumoniae, Klebsiella aerogenes, Pseudomonas aeruginosa, and Pseudomonas fluorescens, sulphate-reducing bacteria, yeasts, molds, and algae.

Hazard Information and Safety to Discharge Directly into Sewer

The composition of Example 1 and of those contemplated by the invention, are not corrosive, toxic, ignitable or reactive, therefore, it is not a characteristically hazardous waste. Spend compositions does not require treatment or dilution for proper/direct transfer to municipal sewer.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A biodegradable lavatory composition comprising about 10 to 52% by weight of potassium formate neutralized from any free ionic radicals, free of potassium hydroxide formic acid and free of potassium positive ion, and water.

2. The composition of claim 1, further comprising a surfactant.

3. The composition of claim 2, wherein the surfactant is about 0.1 to 3% by weight of the composition.

4. The composition of claim 1, further comprising a fragrance and a colorant.

5. The composition of claim 4, the fragrance about 0.01 to 2% by weight of the composition, the colorant is about 0.001 to 0.5% by weight of the composition; and the balance is water.

6. The composition of claim 1, further comprising about 0.1 to 3% by weight of glycerin.

7. The composition of claim 6, further comprising about 0.1 to 3% by weight of siloxane defoamer.

8. The composition of claim 2, wherein the surfactant is a phosphate ester.

9. The composition of claim 8, wherein the phosphate ester surfactant is a polyoxyethylene alkyl phosphate ester.

10. The composition of claim 8, wherein the phosphate ester surfactant is deceth-4 phosphate.

11. The composition of claim 8, wherein the phosphate ester surfactant comprises polyoxyethylene alkyl phosphate ester and deceth-4 phosphate.

12. The composition of claim 11, wherein the polyoxyethylene alkyl phosphate ester is about 0.15% by weight of the composition and deceth-4 phosphate is about 0.25% by weight of the composition.

13. The composition of claim 1, wherein the potassium formate is about 40 to 50% by weight of the composition.

14. The composition of claim 1, wherein the potassium formate is in an amount of about 40 weight % of the composition and further comprises potassium acetate in an amount of about 5% by weight of the composition.

15. The composition of claim 1, wherein a five-day Biological Oxygen Demand (BOD5) is less than about 300 ppm.

16. The composition of claim 1, wherein a five-day Biological Oxygen Demand (BOD5) is less than about 220 ppm.

17. The composition of claim 1, wherein a five-day Biological Oxygen Demand (BOD5) is about 200 ppm.

18. A biodegradable lavatory composition comprising:
about 45% by weight of potassium formate;
about 0.15% by weight of polyoxyethylene alkyl phosphate ester;
about 0.25% by weight of deceth-4 phosphate;
about 0.1% by weight of fragrance;
about 0.03% by weight of siloxane defoamer;
about 0.2% by weight of glycerin;
about 0.0025% by weight of colorant; and
balance of water,
wherein the potassium formate is neutralized from any free ionic radicals, free of potassium hydroxide formic acid and free of potassium positive ion.

19. The composition of claim 18, wherein a five-day Biological Oxygen Demand (BOD5) is about 200 ppm.
